(19) United States
(12) Patent Application Publication
(10) Pub. No.: US 2026/0127710 A1
(43) Pub. Date: May 7, 2026

(54) ADAPTIVE COLOR MATCHING AND ENHANCEMENT OF IMAGE FRAMES IN VIDEO SEE-THROUGH (VST) EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/076,780

(22) Filed: Mar. 11, 2025

Related U.S. Application Data
(60) Provisional application No. 63/716,072, filed on Nov. 4, 2024.

(51) Int. Cl. G06T 5/40; G02B 27/01

(52) U.S. Cl. CPC G06T 5/40; G02B 27/0172; G02B 2027/0138; G02B 2027/014; G02B 2027/0178; G06T 2207/10012; G06T 2207/10016; G06T 2207/10024

(57) ABSTRACT

An apparatus includes at least one imaging sensor configured to capture multiple image frames of a scene. The apparatus also includes at least one processing device configured to obtain at least two of the captured image frames, generate at least one color correction model based on the at least two captured image frames, and apply the at least one color correction model to one or more of the at least two captured image frames in order to obtain color-matched image frames. The color-matched image frames have colors that are more similar to each other compared to colors of the at least two captured image frames.

### CROSS-REFERENCE TO RELATED APPLICATION AND PRIORITY CLAIM

This application claims priority under 35 U.S.C. § 119(e) to U.S. Provisional Patent Application No. 63/716,072 filed on Nov. 4, 2024. This provisional patent application is hereby incorporated by reference in its entirety.

### TECHNICAL FIELD

This disclosure relates generally to image processing systems. More specifically, this disclosure relates to adaptive color matching and enhancement of image frames in video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to adaptive color matching and enhancement of image frames in video see-through (VST) extended reality (XR) or other applications.

In a first embodiment, an apparatus includes at least one imaging sensor configured to capture multiple image frames of a scene. The apparatus also includes at least one processing device configured to obtain at least two of the captured image frames, generate at least one color correction model based on the at least two captured image frames, and apply the at least one color correction model to one or more of the at least two captured image frames in order to obtain color-matched image frames. The color-matched image frames have colors that are more similar to each other compared to colors of the at least two captured image frames.

In a second embodiment, a method includes obtaining, using at least one imaging sensor of an electronic device, at least two of multiple captured image frames of a scene. The method also includes generating, using at least one processing device of the electronic device, at least one color correction model based on the at least two captured image frames. The method further includes applying, using the at least one processing device, the at least one color correction model to one or more of the at least two captured image frames in order to obtain color-matched image frames. The color-matched image frames have colors that are more similar to each other compared to colors of the at least two captured image frames.

In a third embodiment, a non-transitory machine readable medium contains instructions that when executed cause at least one processor of an electronic device to obtain, using at least one imaging sensor of the electronic device, at least two of multiple captured image frames of a scene. The non-transitory machine readable medium also contains instructions that when executed cause the at least one processor to generate at least one color correction model based on the at least two captured image frames. The non-transitory machine readable medium further contains instructions that when executed cause the at least one processor to apply the at least one color correction model to one or more of the at least two captured image frames in order to obtain color-matched image frames. The color-matched image frames have colors that are more similar to each other compared to colors of the at least two captured image frames.

Any one or any combination of the following features may be used with the first, second, or third embodiment. Color histograms and signal-to-noise ratios associated with the at least two captured image frames may be determined, and a determination whether to apply color correction may be based on the color histograms and the signal-to-noise ratios. The at least one color correction model may be generated by determining how to adjust luminance values in foveation or overlapping regions of the at least two captured image frames using gamma correction, determining how to adjust chrominance values in the foveation or overlapping regions of the at least two captured image frames using linear correction, and identifying parameters of the at least one color correction model based on the determinations. The at least one color correction model may be applied by one of: (i) applying the at least one color correction model to foveation regions of the at least two captured image frames (where the foveation regions represent areas of the scene on which a user's eyes are focused) or (ii) applying the at least one color correction model to overlapping regions of the at least two captured image frames (where the overlapping regions include and are larger than the foveation regions). The at least one color correction model may be applied by (i) applying the at least one color correction model to pixel data in portions of the at least two captured image frames and (ii) propagating corrections made to the pixel data in the portions of the at least two captured image frames to pixel data in other portions of the at least two captured image frames. The at least two captured image frames may include at least one of: at least one image frame associated with a user's right eye and at least one image frame associated with a user's left eye; or at least one sequence of image frames. Prior to generation of the at least one color correction model, the at least two captured image frames may be converted from a first image format that lacks luminance data to a second image format that includes luminance data. After application of the at least one color correction model, the color-matched image frames may be converted from the second image format to the first image format or a third image format. A passthrough transformation may be applied to each of the color-matched image frames in order to generate transformed image frames, and the transformed image frames may be rendered for display.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for adaptive color matching and enhancement of image frames in video see-through (VST) extended reality (XR) or other applications in accordance with this disclosure;

FIGS. 3A and 3B illustrate an example architecture supporting adaptive color matching and enhancement of image frames in VST XR or other applications in accordance with this disclosure;

FIG. 4 illustrates an example technique for color matching between image frames in accordance with this disclosure;

FIG. 5 illustrates an example technique for determining whether to perform color matching between image frames in accordance with this disclosure; and

FIG. 6 illustrates an example method for adaptive color matching and enhancement of image frames in VST XR or other applications in accordance with this disclosure.

### DETAILED DESCRIPTION

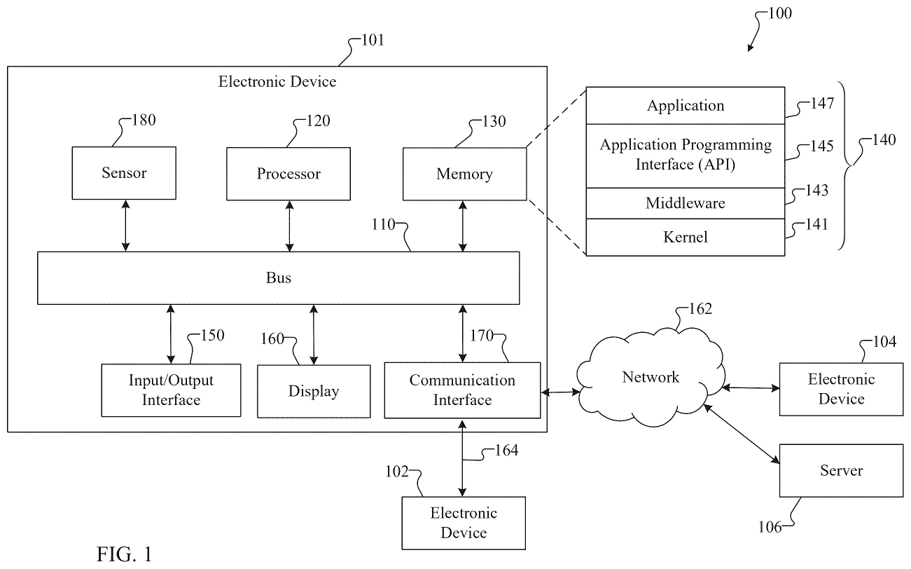

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video sec-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the image quality of the captured image frames can be affected by conditions in the surrounding environment and properties of the imaging sensors themselves. As a result, image frames that are captured, processed, and rendered for display can sometimes undergo different color shifts or otherwise have noticeably different hues or colors. When images with noticeably different colors are displayed to a user's left and right eyes or sequentially, this can make it difficult for the user to process the displayed images and fuse the images being viewed. This can lead to difficulty focusing and even user dizziness, which results in a poor user experience.

This disclosure provides various techniques supporting adaptive color matching and enhancement of image frames in VST XR or other applications. As described in more detail below, at least two captured image frames of a scene can be obtained, such as by using one or more imaging sensors of a VST XR device or other device. At least one color correction model can be generated based on the at least two captured image frames. In some cases, this may include determining how to adjust luminance values in foveation or overlapping regions of the at least two captured image frames using gamma correction, determining how to adjust chrominance values in the foveation or overlapping regions of the at least two captured image frames using linear correction, and identifying parameters of the at least one color correction model based on the determinations. The at least one color correction model is applied to one or more of the at least two captured image frames in order to obtain color-matched image frames. In some cases, the at least one color correction model may be applied to foveation regions or overlapping regions of the at least two captured image frames, where the foveation regions represent areas of the scene on which a user's eyes are focused and where the overlapping regions include and are larger than the foveation regions. Also, in some cases, the at least one color correction model may be applied to pixel data in portions of the at least two captured image frames, and corrections made to the pixel data in the portions of the at least two captured image frames may be propagated to pixel data in other portions of the at least two captured image frames. The color-matched image frames have colors that are more similar to each other compared to colors of the at least two captured image frames, meaning the color-matched image frames are more similar in color relative to each other compared to how similar in color the at least two captured image frames are to each other. In some cases, a passthrough transformation may be applied to each of the color-matched image frames in order to generate transformed image frames, and the transformed image frames may be rendered for display.

In this way, the disclosed techniques can be used to provide adaptive color matching and enhancement of image frames for use in VST XR or other applications. For example, the disclosed techniques can be used to make colors and image qualities of left and right displayed images equal or substantially similar to one another. Among other things, this can be accomplished by analyzing color and quality differences of captured image frames and modifying at least some of the captured image frames in order to more closely match the colors of the captured image frames and reduce or eliminate color differences between the captured image frames. This can result in images that are more pleasing to a user and that reduce or avoid issues with difficulty focusing and user dizziness, resulting in an improved user experience.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to adaptive color matching and enhancement of image frames in VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform adaptive color matching and enhancement of image frames in VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to adaptive color matching and enhancement of image frames in VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

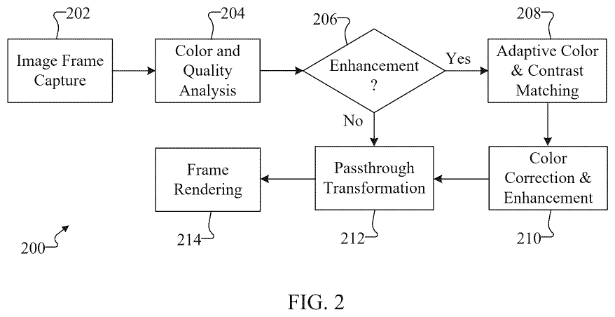

FIG. 2 illustrates an example process 200 for adaptive color matching and enhancement of image frames in VST XR or other applications in accordance with this disclosure. For case of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes an image frame capture operation 202. The image frame capture operation 202 generally operates to obtain image frames captured by the electronic device 101, such as image frames captured using one or more imaging sensors 180 of the electronic device 101. The captured image frames may include image frames of a scene captured by forward-facing or other imaging sensors 180 of the electronic device 101. In some cases, these image frames may represent high-resolution color image frames. Any suitable pre-processing of the captured image frames may be performed here. In some embodiments, the image frames can include left and right image frames, where the image frames are used to render images presented to left and right eyes of a user. Also or alternatively, the image frames can include one or more sequences of image frames, where the image frames in the sequence(s) are captured sequentially over time and are used to render images presented to one or more eyes of a user. For instance, the image frames may include a sequence of left image frames and a sequence of right image frames.

A color and quality analysis operation 204 generally operates to analyze the captured image frames, and an enhancement determination operation 206 generally operates to determine whether at least some of the captured image frames should undergo image enhancement based on the analysis. For example, as described in more detail below, the color and quality analysis operation 204 and the enhancement determination operation 206 can be used to process pairs or other collections of image frames and determine if there are significant color and quality differences between the image frames. In some cases, the image frames may represent left and right image frames to be used to generate rendered images that are presented to the user at the same time. In other cases, the image frames may represent sequential image frames to be used to generate rendered images that are presented to the user sequentially. In general, the color and quality analysis operation 204 can be used to analyze various pairs or other collections of image frames.

The color and quality analysis operation 204 can determine any suitable characteristic(s) of the captured image frames, and the enhancement determination operation 206 can use any suitable characteristic(s) of the captured image frames to determine whether at least some of the captured image frames should undergo image enhancement. In some embodiments, the color and quality analysis operation 204 may generate a color histogram and calculate a signal-to-noise ratio (SNR) for each captured image frame, and the enhancement determination operation 206 can compare the color histograms and SNRs of the captured image frames. If two image frames have color histograms and/or SNRs that differ significantly (such as by more than one or more thresholds), the enhancement determination operation 206 may determine that one or more of those image frames should undergo image enhancement.

If a determination is made that one or more image frames should undergo image enhancement, the image frames are provided to an adaptive color and contrast matching operation 208. The adaptive color and contrast matching operation 208 generally operates to determine how to adjust one or more image frames so that pairs or other collections of image frames have more similar color and quality. For example, the adaptive color and contrast matching operation 208 can determine how at least one of left and right image frames should be modified so that pairs or other collections of left and right image frames have more similar color and quality. As another example, the adaptive color and contrast matching operation 208 can determine how at least one image frame in at least one sequence of image frames should be modified so that sequential image frames have more similar color and quality.

A color correction and enhancement operation 210 generally operates to adjust one or more image frames so that pairs or other collections of image frames have more similar color and quality. The color correction and enhancement operation 210 here can therefore implement the color corrections and enhancements identified by the adaptive color and contrast matching operation 208. For example, the color correction and enhancement operation 210 can modify one or both image frames in a pair of left and right image frames and/or one or both image frames in a pair of sequential image frames. The modifications lead to the generation of color-matched image frames, which represent image frames having more similar color and optionally quality (at least relative to the original versions of the corresponding image frames used to generate the color-matched image frames).

In some embodiments, the adaptive color and contrast matching operation 208 can generate color correction models that identify how image frames should be modified in order to provide desired color and contrast corrections. The color correction and enhancement operation 210 can apply the color correction models to the corresponding image frames in order to generate the color-matched image frames. Also, in some embodiments, the color correction models can be applied to all portions of image frames or to portions of the image frames. For example, in some cases, the color correction models may be applied to only overlapping regions of left and right image frames or overlapping regions of sequential image frames. Overlapping regions of image frames refer to portions of the image frames capturing the same area of a scene. Often times, for instance, the right portions of left image frames and the left portions of right image frames can capture the same part of a scene. In other cases, the color correction models may be applied to only foveation regions of left and right image frames or foveation regions of sequential image frames. Foveation regions of image frames refer to portions of the image frames capturing an area of a scene on which a user's eyes are focused. Overlapping regions will typically include but be larger than foveation regions, since it is very rare that a user's eyes focus on two different areas of a scene not included in the overlapping regions. Note that if overlapping or foveation regions are used in this manner, the color and quality analysis operation 204 could analyze only the overlapping or foveation regions of the image frames (rather than the entire image frames) when calculating the color histograms and SNRs of the image frames.

If the color correction models are applied to only certain portions of the image frames, the remaining portions of the image frames may be handled in any suitable manner. For example, in some cases, the same corrections made to at least one portion of an image frame may be propagated to one or more other portions of the image frame. For instance, the same color changes or other corrections made to the pixel data in one portion of an image frame (such as an overlapping or foveation region) can be applied to pixel data in one or more other portions of the image frame (such as one or more non-overlapping or non-foveation regions). In some cases, this can help to reduce the computational load on the electronic device 101 since smaller color correction models may need to be identified and applied.

Note that color correction and enhancement may be performed here in any suitable image domain. For example, color correction and enhancement can be identified and applied by determining how to adjust luminance data and chrominance data in at least parts of the captured image frames. In some cases, the adjustments to the luminance and chrominance data can be used to identify parameters of the color correction models. Captured image frames may often not include separate luminance data and chrominance data, such as when the captured image frames are in RGB format or another image format that lacks luminance data. In these cases, one or more image conversion functions may optionally be included and used as part of the process 200. For example, prior to generation of color correction models, the captured image frames may be converted from a first image format that lacks luminance data to a second image format that includes luminance data. After application of the color correction models, resulting color-matched image frames can be converted from the second image format to the first image format or a third image format. Any suitable image formats may be supported here. As particular examples, the captured image frames obtained by the image frame capture operation 202 may be in RGB format, and the captured image frames may be converted into YUV or YCbCr format or hue, saturation, and value (HSV) format. Once enhanced, the resulting color-matched image frames can be converted back into RGB format or another format. Note, however, that image format conversion may not be needed, such as when color correction and enhancement can be performed directly in the RGB domain or another domain used by the captured image frames.

After color enhancement and correction has been performed, the color-matched image frames are provided to a passthrough transformation operation 212, which generally operates to apply one or more transformations to the color-matched image frames in order to generate transformed image frames. The passthrough transformation operation 212 can also apply the one or more transformations to the captured image frames (if no color enhancement and correction is needed) in order to generate the transformed image frames. For example, the passthrough transformation operation 212 may be used to compensate for things like registration and parallax errors, which may be caused by factors like differences between the positions of the imaging sensor(s) 180 and the user's eyes. As particular examples, the passthrough transformation operation 212 may apply a rotation and/or a translation to each processed image frame in order to compensate for these or other types of issues. Ideally, the transformations give the appearance that the images presented to the user are captured at the locations of the user's eyes, when the image frames in reality are captured at one or more different locations. Often times, certain transformations can be derived mathematically based on the position and angle of each imaging sensor 180 and the expected or actual positions of the user's eyes. In some cases, one or more of the transformations are static (since these positions and angles will not change), allowing the one or more transformations to be applied quickly.

A frame rendering operation 214 generally operates to create final views of the scene captured in the transformed image frames generated by the passthrough transformation operation 212. The frame rendering operation 214 can also render the final views for presentation to a user of the electronic device 101. For example, the frame rendering operation 214 may process the transformed image frames and perform any additional refinements or modifications needed or desired, and the resulting images can represent the final views of the scene. For instance, a 3D-to-2D warping can be used to warp the final views of the scene into 2D images. The frame rendering operation 214 can also present the rendered images to the user. For example, the frame rendering operation 214 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

The process 200 can therefore be used to analyze the color and image quality of captured image frame, such as by using color histograms and SNRs (possibly only within overlapping or foveation regions of the image frames). Differences between the color histograms can be used to build color correction models, and the color correction models can be applied in order to achieve color and contrast enhancement (at least in the overlapping or foveation regions of the image frames). If applied only to portions of the image frames, the corrections provided by the color correction models can be propagated to other portions of the image frames. Overall, this allows for the generation of color-matched image frames, which have colors that are more similar to each other (compared to colors of the captured image frames processed to form the color-matched image frames). This can be achieved while performing simultaneous color correction with color matching and noise reduction.

Although FIG. 2 illustrates one example of a process 200 for adaptive color matching and enhancement of image frames in VST XR or other applications, various changes may be made to FIG. 2. For example, various operations or functions in FIG. 2 may be combined, further subdivided, replicated, omitted, or rearranged and additional components or functions may be added according to particular needs.

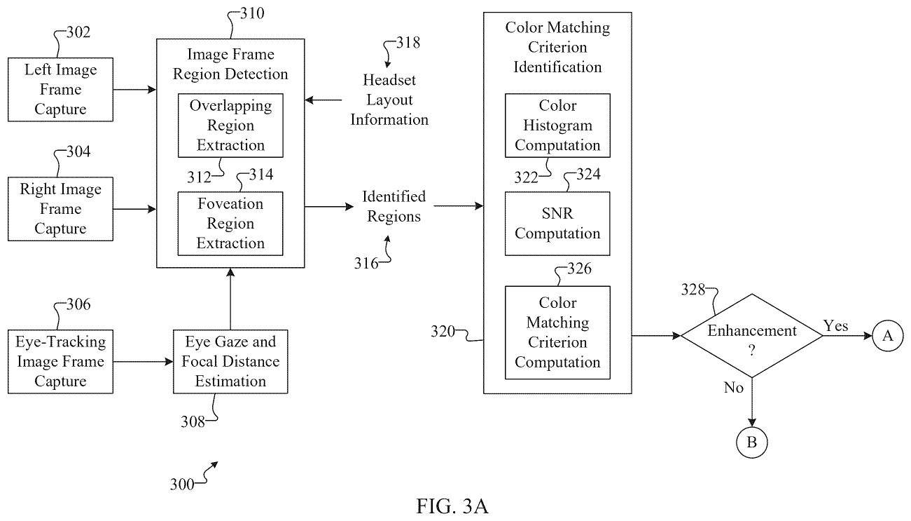

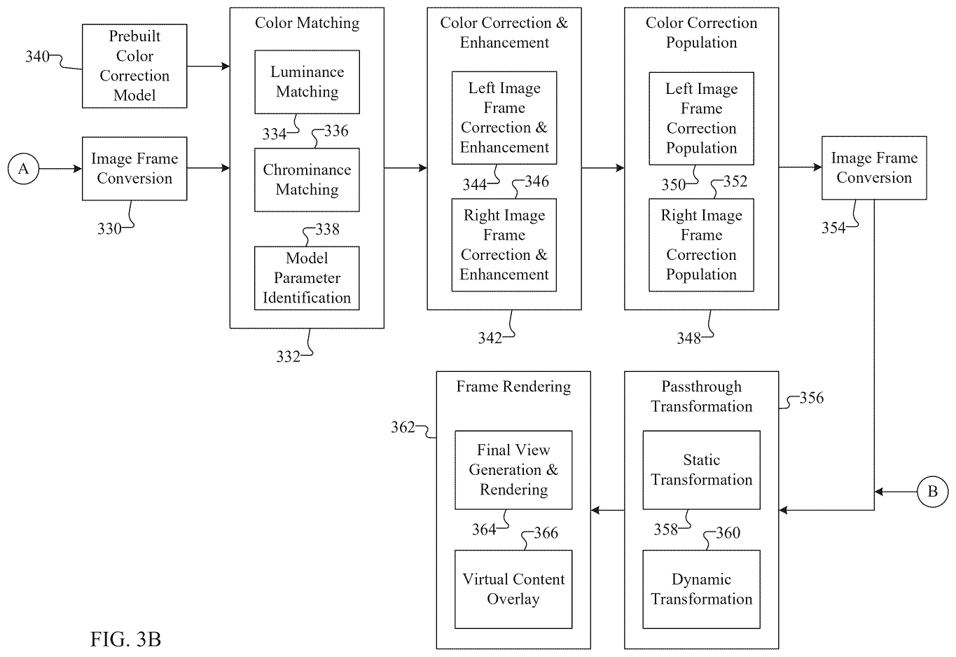

FIGS. 3A and 3B illustrate an example architecture 300 supporting adaptive color matching and enhancement of image frames in VST XR or other applications in accordance with this disclosure. For ease of explanation, the architecture 300 shown in FIGS. 3A and 3B is described as being implemented using the electronic device 101 in the network configuration 100 shown in FIG. 1, where the electronic device 101 may implement the process 200 shown in FIG. 2. However, the architecture 300 may be implemented using any other suitable device(s) and in any other suitable system(s), and the architecture 300 may be used to implement any other suitable process(es) designed in accordance with this disclosure.

As shown in FIG. 3A, the architecture 300 includes a left image capture operation 302 and a right image capture operation 304. These capture operations 302, 304 generally operate to obtain left and right image frames, which can be captured using one or more imaging sensors 180 of the electronic device 101. In some cases, for example, left image frames may be captured using one or more imaging sensors 180 of the electronic device 101, and right image frames may be captured using one or more other imaging sensors 180 of the electronic device 101. If multiple imaging sensors 180 are used, the imaging sensors 180 may or may not face the same general direction. In some embodiments, for instance, the imaging sensors 180 may both point straight ahead, point outward, or point inward.

An eye-tracking image frame capture operation 306 generally operates to obtain image frames capturing a user's eyes. For example, the electronic device 101 may include one or more eye-tracking cameras or other imaging sensors 180 directed towards the user's eyes. These imaging sensors 180 may be used to capture high-resolution or other image frames of the user's eyes. In some cases, the user's eyes may be illuminated, such as by infrared or other illumination sources, while the imaging sensors 180 capture the image frames of the user's eyes.

An eye gaze and focal distance estimation operation 308 generally operates to process the image frames of the user's eyes to estimate the gaze direction and the focal distance of the user's eyes. For example, the eye gaze and focal distance estimation operation 308 may use reflections of illumination from the pupils and corneas of the user's eyes to determine the direction in which it appears the user is gazing and the focal distance at which the user is focusing his or her eyes. The eye gaze and focal distance estimation operation 308 can use any suitable technique(s) to identify the user's gaze direction and focal distance, such as a Pupil Center Corneal Reflection (PCCR) technique.

The captured image frames and the user's gaze direction and focal distance are provided to an image frame region detection operation 310, which generally operates to identify specific regions of the captured image frames. More specifically, the image frame region detection operation 310 can be used to identify overlapping regions and/or foveation regions in the captured image frames. In this example, the image frame region detection operation 310 includes an overlapping region detection function 312, which can identify the portions of the image frames capturing the same area of a scene. The image frame region detection operation 310 also includes a foveation region detection function 314, which can identify the portions of the image frames capturing the area of a scene on which the user's eyes are focused. In some embodiments, the image frame region detection operation 310 can use the overlapping region detection function 312 to identify the overlapping regions of left and right image frames and use the foveation region detection function 314 to identify the portions of the left and right image frames capturing the area of the scene on which the user's eyes are focused (where the identified foveation regions are within the identified overlapping regions). Identified regions 316 selected by the image frame region detection operation 310 can be output for further use. In some cases, the image frame region detection operation 310 may use headset layout information 318 when identifying the identified regions 316. For instance, the headset layout information 318 can identify the layout of imaging sensors 180 used to capture the image frames, which can be useful in determining how the image frames captured by the imaging sensors 180 overlap one another.

A color matching criterion identification operation 320 generally operates to analyze the captured image frames in order to identify the color and image quality of the identified regions 316 within the captured image frames. In this example, the color matching criterion identification operation 320 includes a color histogram computation function 322, which generally operates to calculate a histogram for each image frame based on the colors of the pixel data within the identified region 316 of that image frame. The color matching criterion identification operation 320 also includes an SNR computation function 324, which generally operates to calculate an SNR for each image frame based on the pixel data within the identified region 316 of that image frame. A color matching criterion operation 326 generally operates to compare the color histograms and/or the SNRs.

An enhancement determination operation 328 generally operates to determine whether at least some of the captured image frames should undergo image enhancement based on the color matching criterion. For example, the enhancement determination operation 328 may determine whether the left and right image frames have the same or similar color histograms (at least to within a threshold degree of similarity) and/or the same or similar SNRs (at least to within a threshold degree of similarity). If so, color correction and enhancement can be performed. Otherwise, color correction and enhancement can be skipped, and passthrough transformation may be performed. The color matching criterion operation 326 and the enhancement determination operation 328 may calculate and use any suitable characteristic(s) to determine whether to apply color correction and enhancement.

As shown in FIG. 3B, assuming color correction and enhancement are being performed, an image frame conversion operation 330 can be used, where the image frame conversion operation 330 generally operates to convert the captured image frames from one domain to another. For example, the image frame conversion operation 330 can be used to convert image frames lacking luminance data into image frames having luminance data. As particular examples, the image frame conversion operation 330 may be used to convert image frames in RGB format into image frames in YUV, YCbCr, or HSV format.

A color matching operation 332 generally operates to determine how to more closely match the colors and reduce or remove color differences between the left and right image frames. In this example, the color matching operation 332 includes a luminance matching function 334 and a chrominance matching function 336. The luminance matching function 334 generally operates to determine how to adjust the luminance data for at least one of the left and right image frames in order to more closely match the luminance data of the image frames. The luminance matching function 334 can use any suitable technique(s) for matching luminance data, such as gamma correction. Similarly, the chrominance matching function 336 generally operates to determine how to adjust the chrominance data for at least one of the left and right image frames in order to more closely match the chrominance data of the image frames. The chrominance matching function 336 can use any suitable technique(s) for matching luminance data, such as linear correction. In some embodiments, the luminance matching function 334 and the chrominance matching function 336 may determine how to more closely match the luminance and chrominance data only in the identified regions 316 of the left and right image frames.

The color matching operation 332 also includes a model parameter identification function 338, which generally operates to identify parameters of at least one color correction model based on the adjustments determined by the luminance matching function 334 and the chrominance matching function 336. The model parameter identification function 338 can use any suitable technique(s) for identifying parameters of at least one color correction model. In some embodiments, for instance, the luminance matching function 334 and the chrominance matching function 336 may generate initial color correction models indicating how the luminance and chrominance of image data should be adjusted in one or more of the left and right image frames, and the model parameter identification function 338 could integrate the color correction models with the computed gamma correction coefficients (for luminance correction) and the computed linear correction coefficients (for chrominance correction).

In some embodiments, the color matching operation 332 may optionally have access to or otherwise use a prebuilt color correction model 340. The prebuilt color correction model 340 can define various color matching approaches to be used by the color matching operation 332 when generating the color correction models. For example, the prebuilt color correction model 340 may indicate that gamma correction is used for luminance matching and linear correction is used for chrominance matching as defaults. However, the prebuilt color correction model 340 may be modified to identify other techniques for performing color matching, and the specific techniques used could vary based on a number of factors (including the specific design or application and/or user preference).

The at least one identified color correction model is provided to a color correction and enhancement operation 342, which generally operates to apply the identified color correction model(s) to the identified region(s) 316 of one or more of the left and right image frames. In this example, the color correction and enhancement operation 342 includes a left image frame color correction and enhancement function 344 and a right image frame color correction and enhancement function 346. Each image frame color correction and enhancement function 344 and 346 can apply a color correction model to the identified region 316 of the corresponding left or right image frame. For example, each image frame color correction and enhancement function 344 and 346 may apply gamma correction to the luminance data and linear correction to the chrominance data in the identified region 316 of the corresponding left or right image frame.

A color correction population operation 348 may be used to propagate corrections made to the identified region(s) 316 of the left and/or right image frames to other portions of the left and/or right image frames. In this example, the color correction population operation 348 includes a left image frame correction population function 350 and a right image frame correction population function 352. Each image frame correction population function 350 and 352 can apply color or other corrections made to the identified region 316 of the left or right image frame in other portions of the left or right image frame. For example, each image frame correction population function 350 and 352 may apply gamma correction to the luminance data outside the identified region 316 of the corresponding left or right image frame and linear correction to the chrominance data outside the identified region 316 of the corresponding left or right image frame.

Color-matched image frames generated using the color correction and enhancement operation 342 and the color correction population operation 348 can have colors that are more similar to each other relative to colors of the captured image frames used to produce the color-matched image frames. An image frame conversion operation 354 generally operates to convert the color-matched image frames from one domain to another. For example, the image frame conversion operation 354 can be used to convert image frames having luminance data into another image format (which may or may not include luminance data). As particular examples, the image frame conversion operation 354 may be used to convert image frames in YUV, YCbCr, or HSV format into image frames in RGB format.

The converted color-matched image frames (if color correction and enhancement is performed) or the original captured image frames (if color correction and enhancement is not performed) are provided to a passthrough transformation operation 356, which generally operates to apply one or more transformations to the image frames in order to generate transformed image frames. In this example, the passthrough transformation operation 356 includes a static transformation function 358 and a dynamic transformation function 360. As the names imply, the static transformation function 358 may be used to apply one or more static transformations to the image frames, and the dynamic transformation function 360 may be used to apply one or more dynamic transformations to the image frames. Static transformations may be used to correction for various known distortions that can affect image frames. For instance, the static transformation function 358 may apply one or more transformations to provide camera undistortion (which corrects for image distortions caused by the imaging sensor(s) 180 used to capture image frames), geometric distortion correction (which corrects for geometric distortions created by display lenses through which display panels of the electronic device 101 can be viewed by a user), and color correction (which corrects for things like chromatic aberrations caused when light passes through the display lenses). The dynamic transformation function 360 may apply one or more transformations to provide head pose change compensation (which corrects for movement of the user's head in the time between image frame capture and rendered image display) and parallax correction (which corrects for the different positions of the imaging sensor(s) 180 and the user's eyes).

The transformed image frames are provided to a frame rendering operation 362, which generally operates to create final views of the scene captured in the transformed image frames. In this example, the frame rendering operation 362 includes a final view generation and rendering function 364 and a virtual content overlay function 366. The final view generation and rendering function 364 generally operates to create and render final images that are displayed on one or more display panels of the electronic device 101, such as by warping the final views into 2D images and initiating presentation of rendered 2D images on the display(s) 160. The virtual content overlay function 366 generally operates to overlay virtual content (such as one or more virtual objects) over the final views of the scene. The virtual content here can vary widely depending on the specific application of the electronic device 101.

Although FIGS. 3A and 3B illustrate one example of an architecture 300 supporting adaptive color matching and enhancement of image frames in VST XR or other applications, various changes may be made to FIGS. 3A and 3B. For example, various operations or functions in FIGS. 3A and 3B may be combined, further subdivided, replicated, omitted, or rearranged and additional components, operations, or functions may be added according to particular needs. Also, while the architecture 300 is described as processing left and right image frames, the architecture 300 may also or alternatively be used to process one or more sequences of image frames, such as a sequence of left image frames and a sequence of right image frames. The architecture 300 here can therefore be used to help more closely match the colors and qualities of left and right images displayed to a user and/or more closely match the colors and qualities of sequential images displayed to a user.

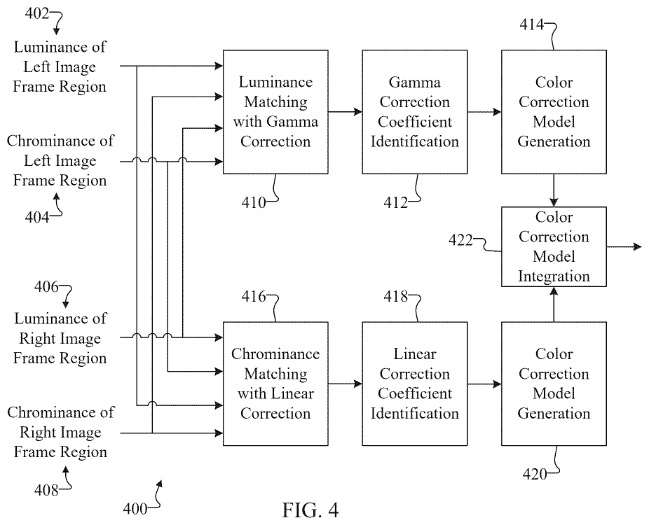

FIG. 4 illustrates an example technique 400 for color matching between image frames in accordance with this disclosure. The technique 400 may, for example, be used as part of the color matching operation 332 in the architecture 300 shown in FIGS. 3A and 3B. For case of explanation, the technique 400 shown in FIG. 4 is described as being implemented using the electronic device 101 in the network configuration 100 shown in FIG. 1, where the electronic device 101 may implement the process 200 shown in FIG. 2 and/or the architecture 300 shown in FIGS. 3A and 3B. However, the technique 400 may be implemented using any other suitable device(s) and in any other suitable system(s), and the technique 400 may be used to implement any other suitable process(es) or architecture(s) designed in accordance with this disclosure.

As shown in FIG. 4, the technique 400 generally involves the processing of luminance data 402 and chrominance data 404 associated with a left image frame and luminance data 406 and chrominance data 408 associated with a right image frame. In some embodiments, the data 402 and 404 is associated with an identified region 316 (such as an overlapping or foveation region) of the left image frame, and the data 406 and 408 is associated with an identified region 316 (such as an overlapping or foveation region) of the right image frame.

A luminance matching operation 410 generally operates to determine how to modify the luminance data 402 and/or the luminance data 406 so that the luminance data of one image frame more closely matches the luminance data of the other image frame. For example, the luminance matching operation 410 can perform luminance matching with gamma correction by creating a luminance matching energy function. A gamma correction coefficient function 412 generally operates to minimize the luminance matching energy function in order to identify gamma correction coefficients, and a color correction model generation function 414 generally operates to create a color correction model using or based on the gamma correction coefficients.

Similarly, a chrominance matching operation 416 generally operates to determine how to modify the chrominance data 404 and/or the chrominance data 408 so that the chrominance data of one image frame more closely matches the chrominance data of the other image frame. For example, the chrominance matching operation 416 can perform chrominance matching with linear correction by creating a chrominance matching energy function. A linear correction coefficient function 418 generally operates to minimize the chrominance matching energy function in order to identify linear correction coefficients, and a color correction model generation function 420 generally operates to create a color correction model using or based on the linear correction coefficients.

A color correction model integration function 422 generally operates to combine the color correction models produced by the color correction model generation functions 414, 420 in order to generate a final color correction model, which could be provided to the color correction and enhancement operation 342 for use. For example, the color correction model integration function 422 may integrate the color correction model with the gamma correction coefficients and the color correction model with the linear correction coefficients. The final color correction model can therefore be used to apply gamma correction coefficients for luminance data adjustment and linear correction coefficients for chrominance data adjustment.

In some embodiments, various operations shown in FIG. 4 may be performed as follows. Let Iₗ(Lₗ(p), Cₗ(p)) represent the left image frame being processed and Iᵣ(Lᵣ(p), Cᵣ(p)) represent the right image frame being processed. For luminance matching, the following may be expected.

$${L}_{l}^{{γ}_{l}} ( {p}_{l} ) = {L}_{r}^{{γ}_{r}} ( {p}_{r} )$$

Here, Lₗ(pₗ) represents the luminance data in the identified region 316 of the left image frame, pₗ(x, y) represents pixels in the identified region 316 of the left image frame, Lᵣ(pᵣ) represents the luminance data in the identified region 316 of the right image frame, and pᵣ(x, y) represents pixels in the identified region 316 of the right image frame. Also, γₗ represents a gamma correction coefficient for the left image frame, and γᵣ represents a gamma correction coefficient for the right image frame. A logarithm function can be applied in order to create an energy function E_{L}, which in some cases may be expressed as follows.

$$min E\_L = 1 / 2 ( ( γ\_l ln ( 1 / N\_l {\sum }_{-} ( i = 1 ) \hat{} ( N\_l ) L\_l ( p\_i ( x , y ) ) - γ\_r ln ( 1 / N\_r {\sum }_{-} ( i = 1 ) \hat{} ( N\_r ) L\_r ( p\_i ( x , y ) ) ) \hat{} 2 / ( σ\_N \hat{} 2 ) + ( ( 1 - γ\_l ) \hat{} 2 + ( 1 - γ\_r ) \hat{} 2 ) / ( σ\_g \hat{} 2 ) )$$

Here, σ_{N} and σ_{g} represent standard deviations of normalized color and luminance errors and gamma coefficients, Nₗ represents a number of pixels in the identified region 316 of the left image frame, and Nᵣ represents the number of pixels in the identified region 316 of the right image frame. By minimizing the luminance energy E_{L}, it is possible to obtain the gamma correction coefficients γₗ and γᵣ.

For chrominance matching, the following may be expected.

$${α}_{l} {C}_{l} ( {p}_{l} ) = {α}_{r} {C}_{r} ( {p}_{r} )$$

Here, Cₗ(pₗ) represents the chrominance data in the identified region 316 of the left image frame, pₗ(x, y) represents pixels in the identified region 316 of the left image frame, Cᵣ(pᵣ) represents the chrominance data in the identified region 316 of the right image frame, and pᵣ(x, y) represents pixels in the identified region 316 of the right image frame. Also, αₗ represents a linear correction coefficient for the left image frame, and αᵣ represents a linear correction coefficient for the right image frame. A logarithm function can be applied in order to create an energy function E_{c}, which in some cases may be expressed as follows.

$$min E\_C = 1 / 2 ( ( α\_l ( 1 / N\_l {\sum }_{-} ( i = 1 ) \hat{} ( N\_l ) L\_l ( p\_i ( x , y ) ) - α\_r ( 1 / N\_r {\sum }_{-} ( i = 1 ) \hat{} ( N\_r ) L\_r ( p\_i ( x , y ) ) ) \hat{} 2 / ( σ\_N \hat{} 2 ) + ( ( 1 - α\_l ) \hat{} 2 + ( 1 - α\_r ) \hat{} 2 ) / ( σ\_g \hat{} 2 ) )$$

Here, σ_{N} and σ_{g} represent standard deviations of normalized color and chrominance errors and linear coefficients, Nₗ is the number of pixels in the overlapping area of the left image, and Nᵣ is the number of pixels in the overlapping area of the right image. By minimizing the chrominance energy E_{c}, it is possible to obtain the linear correction coefficients αₗ and αᵣ.

The final color correction model may be used to apply these gamma and linear correction coefficients to image data of at least one of the left and right image frames. For example, the final color correction model may be used to define the following luminance and chrominance adjustments. The final color correction model can define that gamma correction is applied to the luminance data in the identified region 316 of the left image frame Iₗ(Lₗ(p)), such as in the following manner.

$${L}_{l} ( {p}_{l} ) ← {L}_{l}^{\frac{{γ}_{l}}{γ}} ( {p}_{l} )$$

Here, γₗ represents the gamma correction coefficient for the left image frame, and γ represents a gamma coefficient for linearization. Similarly, the final color correction model can define that gamma correction is applied to the luminance data in the identified region 316 of the right image frame Iᵣ(Lᵣ(p)), such as in the following manner.

$${L}_{r} ( {p}_{r} ) ← {L}_{r}^{\frac{{γ}_{r}}{γ}} ( {p}_{r} )$$

Here, γᵣ represents the gamma correction coefficient for the right image frame, and γ represents the gamma coefficient for linearization.

The final color correction model can also define that linear correction is applied to the chrominance data in the identified region 316 of the left image frame Iₗ(Lₗ(p)), such as in the following manner.

$${C}_{l} ( {p}_{l} ) ← {α}_{l} {C}_{l} ( {p}_{l} )$$

Here, αₗ represents the linear correction coefficient for the left image frame. Similarly, the final color correction model can define that linear correction is applied to the chrominance data in the identified region 316 of the right image frame Iᵣ(Lᵣ(p)), such as in the following manner.

$${C}_{r} ( {p}_{r} ) ← {α}_{r} {C}_{r} ( {p}_{r} )$$

Here, αᵣ represents the linear correction coefficient for the right image frame.

Although FIG. 4 illustrates one example of a technique 400 for color matching between image frames, various changes may be made to FIG. 4. For example, various operations or functions in FIG. 4 may be combined, further subdivided, replicated, omitted, or rearranged and additional components, operations, or functions may be added according to particular needs. Also, while the technique 400 is described as being used to process left and right image frames, the technique 400 may also or alternatively be used to process one or more sequences of image frames, such as a sequence of left image frames and a sequence of right image frames.

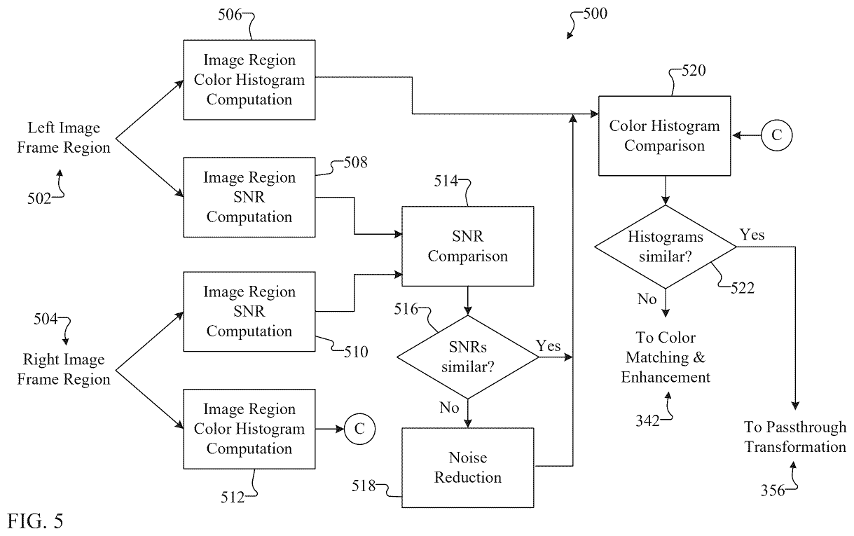

FIG. 5 illustrates an example technique 500 for determining whether to perform color matching between image frames in accordance with this disclosure. The technique 500 may, for example, be used as part of the color matching criterion identification operation 320 and the enhancement determination operation 328 in the architecture 300 shown in FIGS. 3A and 3B. For case of explanation, the technique 500 shown in FIG. 5 is described as being implemented using the electronic device 101 in the network configuration 100 shown in FIG. 1, where the electronic device 101 may implement the process 200 shown in FIG. 2 and/or the architecture 300 shown in FIGS. 3A and 3B. However, the technique 500 may be implemented using any other suitable device(s) and in any other suitable system(s), and the technique 500 may be used to implement any other suitable process(es) or architecture(s) designed in accordance with this disclosure.

As shown in FIG. 5, the technique 500 generally involves the processing of image data 502 associated with an identified region 316 of a left image frame and image data 504 associated with an identified region 316 of a right image frame. An image frame color histogram computation function 506 generally operates to calculate a color histogram of the image data 502 associated with the identified region 316 of the left image frame, and an SNR computation function 508 generally operates to calculate an SNR of the image data 502 associated with the identified region 316 of the left image frame. Similarly, an image frame color histogram computation function 510 generally operates to calculate a color histogram of the image data 502 associated with the identified region 316 of the right image frame, and an SNR computation function 512 generally operates to calculate an SNR of the image data 502 associated with the identified region 316 of the right image frame. Note that while two functions 506, 510 and two functions 508, 512 are shown here, the same logic may be used repeatedly to implement the functions 506, 510, and the same logic may be used repeatedly to implement the functions 508, 512.

An SNR comparison operation 514 compares the calculated SNR values for the image frames, and a determination operation 516 determines if the calculated SNR values are adequately similar (such as within a threshold amount or percentage of one another). If not, this is indicative that one of the image frames may have a lower quality than the other of the image frames. In that case, a noise reduction operation 518 can be applied to at least one of the image frames. For example, the noise reduction operation 518 may apply filtering, interpolation, or other processing technique(s) to try and replace noise in one or both image frames with image data.

Similarly, a color histogram comparison operation 520 compares the calculated color histograms for the image frames, and a determination operation 522 determines if the calculated color histograms are adequately similar (such as within a threshold amount or percentage of one another). If not, this is indicative that one of the image frames may have overall different color relative to the other of the image frames. In that case, the color matching and enhancement operation 342 may be performed, along with subsequent operations of the architecture 300. Otherwise, color matching and enhancement may not be needed, and the passthrough transformation operation 356 may be performed.

In some embodiments, various operations shown in FIG. 5 may be performed as follows. Let the left image frame be represented as I_l (R_l (p_l), Gₗ(pₗ), B_l (p_l)) and the right image frame be represented as I_r (R_r (p_r), Gᵣ(pᵣ), B_r (p_r)). Here, it is assumed that the image frames are in RGB format, although other image formats may be used. A color histogram of the left image frame can be determined, such as in the following manner.

$$H\_l ( R\_l ( p\_l ) , {G}_{l} ( {p}_{l} ) , B\_l ( p\_l ) ) = \{ ■ ( {h\_l}^{⋀} R ( R\_l ( p\_l ) ) @ {h\_l}^{⋀} G ( R\_l ( p\_l ) ) @ {h\_l}^{⋀} B ( R\_l ( p\_l ) ) ) ⊣$$

Here, H_l (R_l (p_l), Gₗ(pₗ), B_l (p_l)) represents the color histogram of the left image frame, and

$${h}_{l}^{R} ( {R}_{l} ( {p}_{l} ) ) , {h}_{l}^{G} ( {R}_{l} ( {p}_{l} ) ) , {h}_{l}^{B} ( {R}_{l} ( {p}_{l} ) )$$

represents histograms of individual red, green, and blue color channels of the left image frame. Similarly, a color histogram of the right image frame can be determined, such as in the following manner.

$$H\_r ( R\_r ( p\_r ) , {G}_{r} ( {p}_{r} ) , B\_r ( p\_r ) ) = \{ ■ ( {h\_r}^{⋀} R ( R\_r ( p\_r ) ) @ {h\_r}^{⋀} G ( R\_r ( p\_r ) ) @ {h\_r}^{⋀} B ( R\_r ( p\_r ) ) ) ⊣$$

Here, H_r (R_r (p_r), Gᵣ(pᵣ), B_r (p_r)) represents the color histogram of the right image frame, and

$${h}_{r}^{R} ( {R}_{r} ( {p}_{r} ) ) , {h}_{r}^{G} ( {R}_{r} ( {p}_{r} ) ) , {h}_{r}^{B} ( {R}_{r} ( {p}_{r} ) )$$

represents histograms of individual red, green, and blue color channels of the right image frame.

For the left image frame, the mean and standard deviation (μₗ, σₗ) can be determined, such as in the following manner.

$$\{ \begin{matrix}{μ}_{l} = \frac{1}{N} {\sum }_{j = 1}^{N} {I}_{1} ( {p}_{1} ( x , y ) j ) ) \\ {σ}_{l}^{2} = \frac{1}{N} {\sum }_{j = 1}^{N} {I}_{l} ( {{p}_{l} ( x , y )}^{2} - {μ}_{l}^{2} )\end{matrix}$$

The SNR of the left image frame can also be determined, such as in the following manner.

$${SNR}_{l} = 10 {log}_{10} ( \frac{{P}_{signal}^{l}}{{P}_{noise}^{l}} )$$

$${P}_{signal}^{l} = {μ}_{l}$$

$${P}_{noise}^{l} = {σ}_{l}$$

### Here

$${P}_{signal}^{l}$$

represents the image signal, and

$${P}_{noise}^{l}$$

represents the noise.

For the right image frame, the mean and standard deviation (μᵣ, σᵣ) can be determined, such as in the following manner.

$$\{ \begin{matrix}{μ}_{r} = \frac{1}{N} {\sum }_{j = 1}^{N} {I}_{r} ( {p}_{r} ( x , y ) ) \\ {σ}_{r}^{2} = \frac{1}{N} {\sum }_{j = 1}^{N} {I}_{r} ( {{p}_{r} ( x , y )}^{2} - {μ}_{r}^{2} )\end{matrix}$$

The SNR of the right image frame can also be determined, such as in the following manner.

$${SNR}_{r} = 10 {log}_{10} ( \frac{{P}_{signal}^{r}}{{P}_{noise}^{r}} )$$

$${P}_{signal}^{r} = {μ}_{r}$$

$${P}_{noise}^{r} = {σ}_{r}$$

### Here

$${P}_{signal}^{r}$$

represents the image signal, and

$${P}_{noise}^{r}$$

represents the image noise.

The color histograms and SNRs can be compared to determine if color matching and correction and/or noise reduction should be performed for the left and right image frames. In some embodiments, for instance, the color histogram comparison operation 520 may determine the difference Dₕ between two color histograms, such as in the following manner.

$${D}_{h} = \sqrt{{\sum }_{i = 0}^{n} {( {h}_{l} ( i ) - {h}_{r} ( i ) )}^{2}}$$

Here, hₗ(i) (i=1, 2, . . . , n) represents the color histogram of the left image frame, hᵣ(i) (i=1, 2, . . . , n) represents the color histogram of the right image frame, and n represents the number of bins in each histogram. The determination operation 522 can compare the difference Dₕ to a threshold T_{D}, and color correction and enhancement can be applied if the difference Dₕ exceeds the threshold T_{D}.

Although FIG. 5 illustrates one example of a technique 500 for determining whether to perform color matching between image frames, various changes may be made to FIG. 5. For example, various operations or functions in FIG. 5 may be combined, further subdivided, replicated, omitted, or rearranged and additional components, operations, or functions may be added according to particular needs. Also, while the technique 500 is described as being used to process left and right image frames, the technique 500 may also or alternatively be used to process one or more sequences of image frames, such as a sequence of left image frames and a sequence of right image frames.

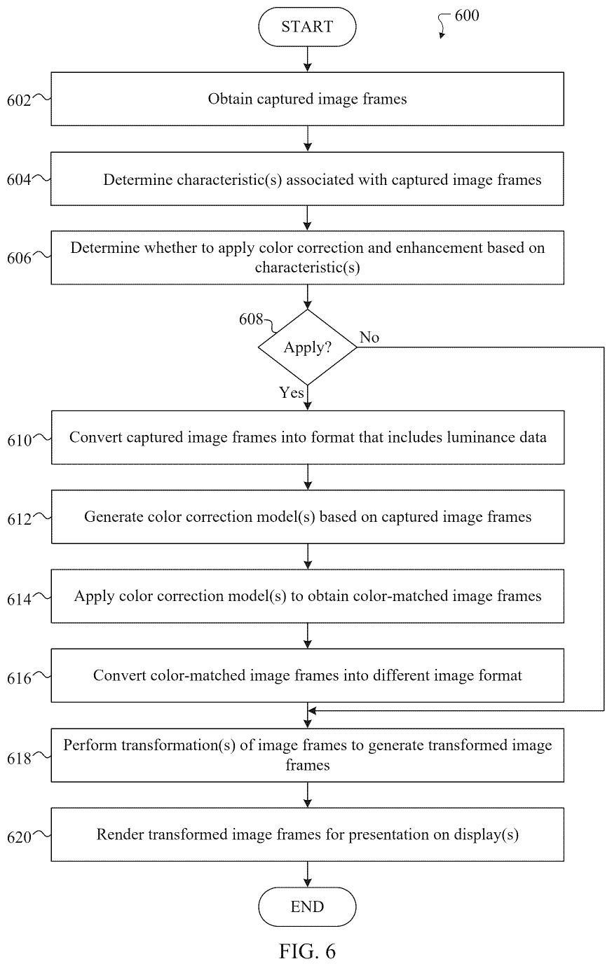

FIG. 6 illustrates an example method 600 for adaptive color matching and enhancement of image frames in VST XR or other applications in accordance with this disclosure. For case of explanation, the method 600 shown in FIG. 6 is described as being performed using the electronic device 101 in the network configuration 100 shown in FIG. 1, where the electronic device 101 may implement the process 200 shown in FIG. 2 and/or the architecture 300 shown in FIGS. 3A and 3B. However, the method 600 may be performed using any other suitable device(s) and in any other suitable system(s), and the method 600 may be implemented using any other suitable process(es) or architecture(s) designed in accordance with this disclosure.

As shown in FIG. 6, multiple captured image frames are obtained at step 602. This may include, for example, the processor 120 of the electronic device 101 obtaining a pair of left and right image frames or a pair of sequential image frames using one or more imaging sensors 180 of the electronic device 101. Any suitable pre-processing of the image frames can be performed here. In some cases, this may include the processor 120 of the electronic device 101 identifying overlapping, foveation, or other identified regions 316 of the image frames.

One or more characteristics of the captured image frames are determined at step 604. This may include, for example, the processor 120 of the electronic device 101 calculating a color histogram and an SNR for each image frame or for the identified region 316 of each image frame. A determination is made whether to apply color correction and enhancement based on the one or more characteristics at step 606. This may include, for example, the processor 120 of the electronic device 101 determining whether the calculated color histograms are or are not equal or similar and whether the calculated SNRs are or are not equal or similar. If a decision is made at step 608 that color correction and enhancement are to be performed, the process can skip to step 618. Otherwise, the process can proceed to step 610.

The captured image frames may optionally be converted into a different format at step 610. This may include, for example, the processor 120 of the electronic device 101 converting the captured image frames from an RGB or other format lacking luminance data into a YUV, YCbCr, HSV, or other format that includes luminance data. One or more color correction models are generated based on the captured image frames at step 612. This may include, for example, the processor 120 of the electronic device 101 determining how to adjust luminance values in the identified regions 316 of the captured image frames using gamma correction, determining how to adjust chrominance values in the identified regions 316 of the captured image frames using linear correction, and identifying parameters of at least one color correction model based on the determinations.

The one or more color correction models are applied to at least one of the captured image frames in order to generate color-matched image frames at step 614. This may include, for example, the processor 120 of the electronic device 101 applying the at least one color correction model to image data in the identified region(s) 316 of at least one of the captured image frames. As a particular example, this may include, for example, the processor 120 of the electronic device 101 applying the at least one color correction model to pixel data in the identified region(s) 316 of at least one of the captured image frames and propagating corrections made to the pixel data in the identified region(s) 316 of at least one of the captured image frames to pixel data in one or more other portions of the at least one of the captured image frames. The color-matched image frames have colors that are more similar to each other compared to colors of the captured image frames used to generate the color-matched image frames. The color-matched image frames may optionally be converted into a different format at step 616. This may include, for example, the processor 120 of the electronic device 101 converting the color-matched image frames from the YUV, YCbCr, HSV, or other format into an RGB or other format.

The resulting color-matched image frames may be used in any suitable manner. In this example, one or more transformations may be performed using the color-matched image frames at step 618, and the resulting transformed image frames may be rendered for display at step 620. This may include, for example, the processor 120 of the electronic device 101 applying one or more passthrough transformations to the color-matched image frames. This may also include the processor 120 of the electronic device 101 rendering the resulting transformed image frames and displaying the rendered images on at least one display 160 of the electronic device 101.

Although FIG. 6 illustrates one example of a method 600 for adaptive color matching and enhancement of image frames in VST XR or other applications, various changes may be made to FIG. 6. For example, while shown as a series of steps, various steps in FIG. 6 may overlap, occur in parallel, occur in a different order, or occur any number of times (including zero times). Also, the method 600 may be used to repeatedly process image frames in order to generate rendered images for display, such as by repeatedly processing left and right image frames and/or one or more sequences of image frames (like a sequence of left image frames and a sequence of right image frames).

It should be noted that the functions shown in or described with respect to FIGS. 2 through 6 can be implemented in an electronic device 101, 102, 104, server 106, or other device(s) in any suitable manner. For example, in some embodiments, at least some of the functions shown in or described with respect to FIGS. 2 through 6 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 6 can be implemented or supported using dedicated hardware components. In general, the functions shown in or described with respect to FIGS. 2 through 6 can be performed using any suitable hardware or any suitable combination of hardware and software/firmware instructions. Also, the functions shown in or described with respect to FIGS. 2 through 6 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An apparatus comprising:
at least one imaging sensor configured to capture multiple image frames of a scene; and
at least one processing device configured to:
obtain at least two of the captured image frames;
generate at least one color correction model based on the at least two captured image frames; and
apply the at least one color correction model to one or more of the at least two captured image frames in order to obtain color-matched image frames, the color-matched image frames having colors that are more similar to each other compared to colors of the at least two captured image frames.

2. The apparatus of claim 1, wherein the at least one processing device is further configured to:
determine color histograms and signal-to-noise ratios associated with the at least two captured image frames; and
determine whether to apply color correction based on the color histograms and the signal-to-noise ratios.

3. The apparatus of claim 1, wherein, to generate the at least one color correction model, the at least one processing device is configured to:
determine how to adjust luminance values in foveation or overlapping regions of the at least two captured image frames using gamma correction;
determine how to adjust chrominance values in the foveation or overlapping regions of the at least two captured image frames using linear correction; and
identify parameters of the at least one color correction model based on the determinations.

4. The apparatus of claim 1, wherein, to apply the at least one color correction model, the at least one processing device is configured to one of:
apply the at least one color correction model to foveation regions of the at least two captured image frames, the foveation regions representing areas of the scene on which a user's eyes are focused; or
apply the at least one color correction model to overlapping regions of the at least two captured image frames, the overlapping regions including and larger than the foveation regions.

5. The apparatus of claim 1, wherein, to apply the at least one color correction model, the at least one processing device is configured to:
apply the at least one color correction model to pixel data in portions of the at least two captured image frames; and
propagate corrections made to the pixel data in the portions of the at least two captured image frames to pixel data in other portions of the at least two captured image frames.

6. The apparatus of claim 1, wherein the at least two captured image frames comprise at least one of:
at least one image frame associated with a user's right eye and at least one image frame associated with a user's left eye; or
at least one sequence of image frames.

7. The apparatus of claim 1, wherein the at least one processing device is further configured to:
prior to generation of the at least one color correction model, convert the at least two captured image frames from a first image format that lacks luminance data to a second image format that includes luminance data; and
after application of the at least one color correction model, convert the color-matched image frames from the second image format to the first image format or a third image format.

8. The apparatus of claim 1, wherein the at least one processing device is further configured to:
apply a passthrough transformation to each of the color-matched image frames in order to generate transformed image frames; and
render the transformed image frames for display.

9. A method comprising:
obtaining, using at least one imaging sensor of an electronic device, at least two of multiple captured image frames of a scene;
generating, using at least one processing device of the electronic device, at least one color correction model based on the at least two captured image frames; and
applying, using the at least one processing device, the at least one color correction model to one or more of the at least two captured image frames in order to obtain color-matched image frames, the color-matched image frames having colors that are more similar to each other compared to colors of the at least two captured image frames.

10. The method of claim 9, further comprising:
determining color histograms and signal-to-noise ratios associated with the at least two captured image frames; and
determining whether to apply color correction based on the color histograms and the signal-to-noise ratios.

11. The method of claim 9, wherein generating the at least one color correction model comprises:
determining how to adjust luminance values in foveation or overlapping regions of the at least two captured image frames using gamma correction;
determining how to adjust chrominance values in the foveation or overlapping regions of the at least two captured image frames using linear correction; and
identifying parameters of the at least one color correction model based on the determinations.

12. The method of claim 9, wherein applying the at least one color correction model comprises one of:
applying the at least one color correction model to foveation regions of the at least two captured image frames, the foveation regions representing areas of the scene on which a user's eyes are focused; or
applying the at least one color correction model to overlapping regions of the at least two captured image frames, the overlapping regions including and larger than the foveation regions.

13. The method of claim 9, wherein applying the at least one color correction model comprises:
applying the at least one color correction model to pixel data in portions of the at least two captured image frames; and
propagating corrections made to the pixel data in the portions of the at least two captured image frames to pixel data in other portions of the at least two captured image frames.

14. The method of claim 9, wherein the at least two captured image frames comprise at least one of:
at least one image frame associated with a user's right eye and at least one image frame associated with a user's left eye; or
at least one sequence of image frames.

15. The method of claim 9, further comprising:
prior to generation of the at least one color correction model, converting the at least two captured image frames from a first image format that lacks luminance data to a second image format that includes luminance data; and
after application of the at least one color correction model, converting the color-matched image frames from the second image format to the first image format or a third image format.

16. The method of claim 9, further comprising:
applying a passthrough transformation to each of the color-matched image frames in order to generate transformed image frames; and
rendering the transformed image frames for display.

17. A non-transitory machine readable medium containing instructions that when executed cause at least one processor of an electronic device to:
obtain, using at least one imaging sensor of the electronic device, at least two of multiple captured image frames of a scene;
generate at least one color correction model based on the at least two captured image frames; and
apply the at least one color correction model to one or more of the at least two captured image frames in order to obtain color-matched image frames, the color-matched image frames having colors that are more similar to each other compared to colors of the at least two captured image frames.

18. The non-transitory machine readable medium of claim 17, further containing instructions that when executed cause the at least one processor to:
determine color histograms and signal-to-noise ratios associated with the at least two captured image frames; and
determine whether to apply color correction based on the color histograms and the signal-to-noise ratios.

19. The non-transitory machine readable medium of claim 17, wherein the instructions that when executed cause the at least one processor to generate the at least one color correction model comprise:
instructions that when executed cause the at least one processor to:
determine how to adjust luminance values in foveation or overlapping regions of the at least two captured image frames using gamma correction;
determine how to adjust chrominance values in the foveation or overlapping regions of the at least two captured image frames using linear correction; and
identify parameters of the at least one color correction model based on the determinations.

20. The non-transitory machine readable medium of claim 17, wherein the instructions that when executed cause the at least one processor to apply the at least one color correction model comprise:
instructions that when executed cause the at least one processor to:
apply the at least one color correction model to pixel data in portions of the at least two captured image frames; and
propagate corrections made to the pixel data in the portions of the at least two captured image frames to pixel data in other portions of the at least two captured image frames.
